(19) United States
(12) Patent Application Publication
(10) Pub. No.: US 2015/0332299 A1
(43) Pub. Date: Nov. 19, 2015

(54) SERVICE PRICING METHOD BASED ON SERVICE INDUSTRY AUCTION SYSTEM

(71) Applicant: SHANGHAI OCEANBRIDGE INTERNATIONAL TRADING CO., LTD., Shanghai (CN)

(72) Inventors: Cheng ZHANG, Shanghai (CN); Yun MA, Shanghai (CN); Yujie ZHANG, Shanghai (CN); Hongjun WANG, Shanghai (CN)

(21) Appl. No.: 14/762,818

(22) PCT Filed: Dec. 26, 2013
(86) PCT No.: PCT/CN2013/090580

§ 371 Date: Jul. 23, 2015

(30) Foreign Application Priority Data
Jan. 27, 2013 (CN) 201310029294.6

(51) Int. Cl. G06Q 30/02; G06Q 30/08

(52) U.S. Cl. CPC G06Q 30/0206; G06Q 30/0202; G06Q 30/08

(57) ABSTRACT

The present invention relates to the technical field of service pricing methods, and in particular, to a service pricing method based on a service industry auction system. The present invention adopts the following technical solution, comprising: establishing a service-industry auction system; establishing a model of factors affecting a service price; calculating an influence coefficient of each influencing factor on the price according to historical transaction data of the auction system; the system predicting a market reference price of a service to be auctioned in future auctions; and continually correcting the market reference price predicted by the system according to the historical transaction data. The method of the present invention is used for pricing the service industry based on a service-industry auction system, fully considers the change of the service industry in the monopolistic competition market, and prices different services according to historical representations of different service auctioneers and factors affecting the price to achieve the purpose of facilitating service transactions. The method of the present invention saves many intermediate links for concluding a transaction, has a very good social network communication effect, and has a profound influence on employment increase.

### TECHNICAL FIELD

The invention relates to the technical field of service pricing method, especially relates to a service pricing method based on auction system.

### TECHNICAL BACKGROUND

Because the service provider is unique, consumers are more difficulty to distinguish the quality of the service before their purchase; it is difficulty to make a price for service. By the development of service industry, internet auction and social network booming, service auction with social attributes becomes much popular, making reasonable pricing for service play an inestimable role in the deal.

People not only want to buy services through service auction system, but also hope to understand the service before buying, especially know the service price information, and share the service with friends and make friends, therefore, to study how to make a price for the service based on auction system has become a very necessary work.

The traditional service pricing method cannot make the exact price for every service provider and cannot price according to the market changes. The invention considering the changes in the market, every service provider's historical performance, and the factors of influencing the price, makes every service price, in order to facilitate deals. The invention saves many intermediate links, has social network communication effort.

### CONTENT OF THE INVENTION

In view of this, this invention, service pricing method based on auction system, used for pricing service on auction system.

To solve above problems, the invention publish service pricing method based on auction system, the Steps include:

S1: To establish the service auction system

S2: To establish a model of the factors influencing the service price:

S3: according to the auction system historical transaction data to calculate the influence coefficient of each influence factor on the price;

S4: To predict future auction marketing reference price in service;

S5: According to historical transaction data to revise forecast market reference price constantly.

Further, the S1 includes the steps of:

Auctioneers can enter personal information, including service industry, age, gender, geographic location, service time, service description, and the lowest price per hour for the auction; customers bid higher than the lowest price, at the end of the highest bidder wins the bid; we set up customer evaluation system and social recommendations functions.

S2 includes:

The influencing factors of the service price are a1, a2, a3, a4, a5, a6, a7, the auction system set algorithm for each factor, which is used to measure the factors' impact value on the final service price:

a1: auctioneer's historical experience value:

a1=a11*P+a12*H;

P=auctioneer's average strike price;

H=auctioneer's total transaction time/the average total transaction time in the same industry*all of the auctioneers' average strike price in the same industry

a11 is coefficient of P on the auctioneer's historical experience value, a12 is coefficient of H on the auctioneer's historical experience value

T_aver=the average total transaction time in the same industry=total transaction time in the same industry/numbers of auctioneers in the transaction deal

H_rate=auctioneer's total transaction time/the average total transaction time in the same industry=auctioneer's total transaction time/T_aver;

Pw=all of the auctioneers' average strike price in the same industry=total avenue in the same industry/total transaction time in the same industry;

H=H_rate*Pw;

P_deal=Every time transaction price:

T_deal=Every time transaction time;

P=Σ(P_deal*T_deal)/ΣT_deal;

So a1=a11*Σ(P_deal*T_deal)/ΣT_deal+a12*H_rate*Pw;

According to the annual national services price statistics, suppose each service benchmark price is P0, P0 includes the industry, gender, age, geographic location and time of providing services, if the auctioneer has no historical experience on the platform, the system set is the reference initial price is P0.

a2: Customer comment value, the customer comments are provided by the auction service's buyers:

On the website listed customer comments score table, set full marks is 10, customer comment is divided into 1.2.3.4.5 five grades, 2Pw are transformed into a scale from 1 to 10. When an auctioneer's customer comments reach the average value of all of the website customer comments, the customer comment plays a role for Pw. If the auctioneer has no customer comments, the default is P0.

a2=⅕(K−K_aver)×Pw+Pw;

K=customer comments;

K_aver=average value of all of the website customer comments

a3: The value of auctioneer's fans

If the total number of the website is N, the number of fans of the user who has the most fans is n, the average number of user's fans is m. If the probability of average repost is v, the total number of reading the post of user who has the most fans: n+n*m*v=n(1+m*v);

The number of fans of the user who has the average number of fans is m, the number of reading the post of user who has the average fans:

m+m*v=m(1+m*v);

By the above assumptions, a3 curve passes through three points: [0, 0], [m(1+mv), P0], [n(1+mv), 2 P0], we can use these three sets of data fitting a quadratic polynomial to quantify the role of fans in pricing:

data is: x=[0m(1+mv)n(1+mv)]; y=[0 P2P0];

Poly=polyfit(x,y,2)=p; p is the 1×3 vector, p(1), p(2), p(3) are the coefficient of the quadratic polynomial, This polynomial is p(1)×x̂2+p(2)×x+p(3);
For the every user on the website, if the user's fans is n0, the total number of the user's fans:
N_fans=n0+n0*m*v=n0(1+m*v), the role of fans in pricing:

a3=f(N_fans)=p(1)*Nfans*N_fans+p(2)*N_fans+p(3)3

a4: The value of quantity of uploading certificates;

If the most certificates the auctioneer uploading is 10,

The average number of uploading certificates in one industry is Z_aver,

Z_aver=all of the uploading certificates in one industry/the number of auctioneer in the industry

When an auctioneer uploaded 10 certificates, the value of his/her certificates is 2P0; when an auctioneer uploaded the number of certificates as the same as the average number of the auctioneer's certificates on the website, the value of his/her certificates is P0; when an auctioneer did not upload certificates, his/her certificate value is 0. we can use these three sets of data fitting a quadratic polynomial to quantify the role of uploading certificates in pricing:

Data is: x=[0Z_{—}aver 10],y=[0 P0 2P0]; poly=polyfit(x,y,2)=p,

Poly=polyfit(x,y,2)=p; p is the 1×3 vector, p(1), p(2), p(3) are the coefficient of the quadratic polynomial,

This polynomial is p(1)×x̂2+p(2)×x+p(3);

If an auctioneer uploading certificates in an industry is Z, a4=p(1)*Z*Z+p(2)*Z+p(3)

a5: Upset price

a5=P*=upset price;

If the auction upset price is more than 2 times of the average price, or less than half of the average price, the web site will not calculate the reference price, and not give the reference price.

a5: Friend's recommendation value.

Friend's recommendation value is composed of two parts: the person who recommends the user register the website and friends on the site recommendation after the user registered (friends here refer to not buying the service, friends' recommendation: agree, disagree.).

We take rankings and the number of followers to calculate the value of the recommendation on the site.

a6=a61*the value of the person who recommends the user register the website+a62*the value of friends on the site recommendation after the user registered;

a61 is coefficient of the value of the person who recommends the user register the website on the friends recommendation value.

a62 is coefficient of the value of friends on the site recommendation after the user registered on the friends recommendation value.
The value of the person who recommends the user register the website=a611*the value of the person ranking+a612*the value of the person's followers;
Pref=the value of the person who recommends the user register the website;
The person referred to recommend auction website role:
Ref_rank=rankings of the person who recommends the user register the website:
Pref_rank=value of the person who recommends the user register the website;
Pref_rank=(1−ranking/total number of persons)*P0;
Pref_fans=followers' value of the person who recommends the user register the website;
Pref_fans=f(Ref_fans);

followers' value of the person who recommends the user register the website is calculated in value of auctioneer's fans in a3:

f(Ref_fans)=p(1)*Ref_fans*Ref_fans+p(2)*Ref_fans+p(3);
Ref_fans1=number of Direct followers;
Ref_fans2=number of indirect followers;
Ref_fans=Ref_fans1+Ref_fans2;

As to friends on the site recommendation after the user registered: Recommendation on friends on the website:

Some friend recommendation value=all “agree” values+all “disagree” values;

Every “agree” value=a611 this friend's rank value+a612*the number of followers of this friend value,

Every “agree” value=−(a611*this friend's rank value+a612*the number of followers of this friend value),
a611 is coefficient of the friend rank value
a62 is coefficient of the number of followers value
Fri_rankA=friend's rank who published a “agree”;
Fri_fansA=The number of followers of the friend who published “agree”;
Fri_rankD=The ranking of the friend who published “disagree”;
Fri_fansD=The number of followers of the friend who published “disagree”
Pfri=the value of friends on the site recommendation after the user registered;
Pfri_rank=all friend's rank value=[Σ(1−Fri_rankA/N)−Σ(1−Fri_rankD/N)]*P0;

$$Pfri\_fans = Σ f ( Fri\_fansA ) - Σ f ( Fri\_fansD ) = [ p ( 1 ) * Fri\_fansA * Fri\_FansA + p ( 2 ) * Fri\_fansA + p ( 3 ) ] - [ p ( 1 ) * Fri\_fansD * Fri\_fansD + p ( 2 ) * Fri\_fansD + p ( 3 ) ] ;$$

For a certain industry, calculating each friend's recommendation value, in all of auctioneers who were recommended, using the lowest friend's recommendation value as the friend's recommendation minimum value Pmin, Pmin is 0, using highest friend's recommendation value as the friend's recommendation maximum Pmax,Pmax is 2p0, average recommendation value is Paver, Paver is p0

Paver=average recommendation value=total of all of the auctioneers's friends' recommendation values in this industry/number of auctioneers in the industry, so data is: (Pmin, 0), (Paver, P0), (Pmax, 2P0), with the three sets of data fitting a quadratic polynomial:

x=[Pmin, Paver, Pmax], y=[0, P0, 2P0], Poly=polyfit (x, y,2)=p, P is a 3×1 vector; if an auctioneer's friend's recommendation value is Pown, this auctioneer's friend's recommendation value:

Pf=p(1)*Pown*Pown+p(2)*pown+p(3);

a6=a61*Pref+a62*Pfri

=a61*(a611*Pref_rank+a612*Pref_fans)+a62*(a611*Pfri_rank+a612*Pfri_fans)ₒ

a7: Auctioneer website ranking;

a7=(1−this auctioneer website ranking/total number of auctioneers)*average transaction price of all of the auctioneers in the industry.

=(1−Rank/N)*Pwₒ

S3 includes: The influencing factors of the service price are a1, a2, a3, a4, a5, a6, a7, corresponding the influence coefficients are x1, x2, x3, x4, x5, x6, x7, by all of the historical transaction price to calculate the influence coefficients.

$$\begin{matrix}Transaction price = a 1 * x 1 + a 2 * x 2 + a 3 * x 3 + a 4 * x 4 + a 5 * x 5 + a 6 * x 6 + a 7 * x 7 \\ = x 1 * ( a 11 * P\_aver + a 12 * H ) + x 2 * a 2 + x 3 * a 3 + x 4 * a 4 \\ + x 5 * a 5 + x 6 * ( a 61 * Pref + a 62 * Pfri ) + x 7 * a 7 \\ = x 1 * a 11 ( P\_aver - H ) + x 1 * H + x 2 * a 2 + x 3 * a 3 + x 4 * a 4 \\ + x 5 * a 5 + x 6 * a 61 * ( Pref - Pfri ) + x 6 * Pfri + ( 1 - x 1 - x 2 - … - x 6 ) * a 7 \\ = x 1 * a 11 ( P\_aver - H ) + x 6 * a 61 * ( Pref - Pfri ) + x 1 * ( H - a 7 ) \\ + x 2 * ( a 2 - a 7 ) + x 3 * ( a 3 - a 7 ) + x 4 * ( a 4 - a 7 ) + x 5 * ( a 5 - a 7 ) \\ + x 6 * ( Pfri - a 7 ) + a 7\end{matrix}$$

Because of the nonlinear equation, we use Newton method to solve this nonlinear equation, and get x1, X2, X3, x4, X5, X6, a11, a61.

S4 includes: according to the coefficients in S3, the auction system can predicts the marketing reference price.

S5: each of the seven groups of historical transaction data can be calculated by a group of influence coefficients, when the system of transaction data continues to increase, the system automatically use the historical transaction records and relevant information, to calculate multi groups of influence coefficients, to find coefficients changing regularities, so as to continuously modify the predicted marketing reference price.

Implementation

In order to make the invention more clearly, the technical scheme and the advantages of the invention are more clearly understood, the followings make further explanation.

The example of the invention is based on the relevant statistical data of American service industry, but the method of the invention is not restricted by the geographical and the language type.

S1 To establish the service auction system

Using IT technology to establish the auction system platform. Auctioneers can enter personal information, including service industry, age, gender, geographic location, service time, service description, and the lowest price per hour for the auction; customers bid higher than the lowest price, at the end of the highest bidder wins the bid; we set up customer evaluation system and social recommendations functions.

S2, The influencing factors of the service price are a1, a2, a3, a4, a5, a6, a7, the auction system set algorithm for each factor, which is used to measure the factors' impact value on the final service price:

a1: auctioneer's historical experience value:

a1=a11*Σ(P_deal*T_deal)/ΣT_deal+a12*H_rate*Pwₒ

a2: Customer comment value, the customer comments are provided by the auction service's buyers;

a2=⅕(K−K_aver)×Pw+Pwₒ

a3: The value of auctioneer's fans

a3=f(N_fans)=p(1)*N_fans*N_fans+p(2)*N_fans+p(3)3

a4: The value of quantity of uploading certificates;

a4=p(1)*Z*Z+p(2)*Z+p(3)

a5: Upset price

a5=P*=upset price

a6: Friend's recommendation value.

a6=a61*Pref+a62*Pfri

=a61*(a611Pref_rank+a612*Pref_fans)+a62*(a611*Pfri_rank+a612*Pfri_fans)ₒ

a7: Auctioneer website ranking;

a7=(1−Rank/N)*Pwₒ

S3 includes: The influencing factors of the service price are a1, a2, a3, a4, a5, a6, a7, corresponding the influence coefficients are x1, x2, x3, x4, x5, x6, x7, by all of the historical transaction price to calculate the influence coefficients.

$$\begin{matrix}Transaction price = a 1 * x 1 + a 2 * x 2 + a 3 * x 3 + a 4 * x 4 + a 5 * x 5 + a 6 * x 6 + a 7 * x 7 \\ = x 1 * ( a 11 * P\_aver + a 12 * H ) + x 2 * a 2 + x 3 * a 3 + x 4 * a 4 \\ + x 5 * a 5 + x 6 * ( a 61 * Pref + a 62 * Pfri ) + x 7 * a 7 \\ = x 1 * a 11 ( P\_aver - H ) + x 1 * H + x 2 * a 2 + x 3 * a 3 + x 4 * a 4 \\ + x 5 * a 5 + x 6 * a 61 * ( Pref - Pfri ) + x 6 * Pfri + ( 1 - x 1 - x 2 - … - x 6 ) * a 7 \\ = x 1 * a 11 ( P\_aver - H ) + x 6 * a 61 * ( Pref - Pfri ) + x 1 * ( H - a 7 ) \\ + x 2 * ( a 2 - a 7 ) + x 3 * ( a 3 - a 7 ) + x 4 * ( a 4 - a 7 ) + x 5 * ( a 5 - a 7 ) \\ + x 6 * ( Pfri - a 7 ) + a 7\end{matrix}$$

Because of the nonlinear equation, we use Newton method to solve this nonlinear equation, and get x1, X2, X3, X4, X5, X6, a11, a61.

We assume that there are 5 industries on the site. 8 auctioneers made 9 deals, the data is as follows:

| | Industry 1 | | | Industry 2 | | Industry 3 | | Industry 4 | Industry 5 |
|---|---|---|---|---|---|---|---|---|---|
| Parameter | Auctioneer a | Auctioneer b | | Auctioneer c | Auctioneer d | Auctioneer e | Auctioneer f | Auctioneer g | Auctioneer h |
| P_deal | 23 | 24 | 25 | 35 | 36 | 47 | 48 | 41 | 23 |
| P_aver | 23 | 24.4286 | | 35 | 36 | 47 | 48 | 41 | 23 |
| T_deal | 2.95 | 4 | 3 | 3 | 2 | 2 | 1.5 | 3 | 4 |
| T_aver | 3.3167 | | | 2.5 | | 1.75 | | 3 | 4 |
| Pw | 24.005 | | | 35.4 | | 47.4286 | | 41 | 23 |
| H_rate | 0.8894 | 1.206 | 0.9045 | 1.2 | 0.8 | 1.1429 | 0.8571 | 1 | 1 |
| H | 21.35 | 28.95 | 21.71 | 42.48 | 28.32 | 54.2041 | 40.6531 | 41 | 23 |
| a1 | 22.505 | 25.785 | 23.61 | 37.244 | 33.696 | 49.1612 | 45.7959 | 41 | 23 |

Suppose P's share is 0.7, H's share 0.3

| K | K_aver − | K_aver − | 0.8321 + | K_aver − | 0.3672 + | K_aver − | 0.2711 + | K_aver − | K_aver − |
|---|---|---|---|---|---|---|---|---|---|
| | 0.443 | 0.0526 | K_aver | 0.1271 | K_aver | 0.3614 | K_aver | 0.1829 | 0.3034 |
| | 5.957 | 6.3474 | 7.2321 | 6.2729 | 6.7672 | 6.0386 | 6.6711 | 6.2171 | 6.0966 |
| K_aver | 6.4 | | | | | | | | |
| a2 | 21.8782 | 23.7525 | 28 | 34.5 | 38 | 44 | 50 | 39.5 | 21.6044 |
| n0 | 25 | 32 | 32 | 28 | 36 | 41 | 46 | 33 | 21 |
| P0 | 22 | | | 33 | | 45 | | 40 | 36 |
| N | 1000 | | | | | | | | |
| n | 100 | | | | | | | | |
| m | 30 | | | | | | | | |
| v | 0.1 | | | | | | | | |
| poly | −0.0042 | 0.859 | | −0.0063 | 1.2886 | −0.0086 | 1.7571 | −0.0076 | −0.004 |
| a3 | 20.53 | 23.1872 | 23.1872 | 31.1416 | 38.2248 | 57.5845 | 62.629 | 43.2663 | 24.336 |
| Z | 3 | 2 | | 2 | 2 | 6 | 5 | 2 | 1 |
| Z_aver | 2.5 | | | 2 | | 5.5 | | 2 | 1 |
| poly | −0.5867 | 10.2667 | 0 | −1.2375 | 18.975 | 0.1818 | 7.1818 | −1.5 | −1.8667 |
| a4 | 25.5198 | 18.1866 | 18.1866 | 32.8 | 32.8 | 49.6356 | 40.454 | 40 | 21 |
| P* | 21 | 23 | 25 | 35 | 36 | 45.5 | 47 | 41 | 23 |
| a5 | 22.5 | 24 | 25 | 35 | 36 | 45.5 | 47 | 41 | 23 |

| | | | | | | | | |
|---|---|---|---|---|---|---|---|---|
| Ref_rank | 35 | 40 | 30 | 28 | 35 | 25 | 32 | 32 |
| Pref_rank | 21.23 | 21.12 | 32.01 | 32.076 | 43.425 | 43.875 | 38.72 | 20.328 |
| Ref_fans1 | 51 | 40 | 39 | 50 | 43 | 48 | 45 | 46 |
| Ref_fans2 | 204 | 160 | 156 | 200 | 132 | 192 | 180 | 184 |
| Pref_fans | 32.8848 | 27.64 | 40.6731 | 48.68 | 59.6539 | 64.5264 | 54.8955 | 29.256 |

Suppose Pref_rank's share is 0.35, Pref_fans's share is 0.65

| | | | | | | | | |
|---|---|---|---|---|---|---|---|---|
| Pref | 28.8056 | 25.358 | 37.641 | 42.8686 | 53.9738 | 57.2984 | 54.8955 | 26.1312 |
| Fri_rank | 45 | 48 | 50 | 56 | 60 | 48 | 48 | 39 |
| | 20.01 | 20.944 | 31.35 | 31.152 | 42.3 | 42.84 | 38.08 | 20.181 |
| Fri_fans | 43 | 38 | 37 | 35 | 28 | 30 | 32 | 41 |
| | 29.1712 | 26.5772 | 39.0535 | 37.3835 | 42.4564 | 44.973 | 42.1984 | 26.896 |
| Pfri | 26.601 | 24.6056 | 36.3573 | 35.2025 | 42.4017 | 44.2265 | 40.757 | 24.5458 |

Suppose Fri_rank's share is 0.4, Fri_fans's share is 0.6

| | | | | | | | | |
|---|---|---|---|---|---|---|---|---|
| a6 | 27.4828 | 24.9066 | 36.8708 | 38.2689 | 47.0305 | 49.4553 | 44.1478 | 25.18 |
| rank | 68 | 46 | 60 | 45 | 42 | 33 | 50 | 44 |
| a7 | 20.504 | 20.988 | 31.02 | 31.515 | 43.1111 | 45.515 | 38 | 20.076 |

So:x1=0.1449, x2=0.1578, x3=0.0385, x4=0.0538, x5=0.5704, x6=0.0218, x7=0.0187, a11=0.7, a62=0.4

S4. according to the coefficients in S3, the auction system can predicts the marketing reference price.

For example:

One auctioneer on the website did not make transactions, the system extracts the latest auction data as follows, according to the existing data to predict this auctioneer marketing reference price.

| | |
|---|---|
| Parameter | Data |

| | | |
|---|---|---|
| P_aver | 24.5 | |
| Pw | 24 | |
| H | 25.2 | |
| a1 | 24.71 | |
| K_aver_own | 6.68 | |
| K_aver | 6.4 | |
| a2 | 25.344 | |
| fans | 33 | |
| P0 | 22.5 | |
| a3 | 24.3111 | |
| Z | 3 | |
| Z_aver | 2.75 | |
| a4 | 24.1663 | |
| a5 | 24.5 | |
| Ref_rank | 38 | 21.645 |
| Ref_fans | 41 | 28.7943 |
| Pref | 26.2335 | |
| Fri_rank | 47 | 21.4425 |
| Fri_fans | 34 | 24.9016 |
| Pfri | 23.6909 | |
| a6 | 24.7079 | |
| rank | 45 | |
| a7 | 21.4875 | |

According to S3, we can get the influence coefficient, and then get the marketing reference price is 24.7311.

S5, each of the seven groups of historical transaction data can be calculated by a group of influence coefficients, when the system of transaction data continues to increase, the system automatically use the historical transaction records and relevant information, to calculate multi groups of influence coefficients, to find coefficients changing regularities, so as to continuously modify the predicted marketing reference price.

Service pricing method based on service industry auction system is introduced above, we use implementation example to explain the principle of the invention, which is used to help understand the method and the core thought of the invention, and is not to be used for limiting of the invention, where within the spirits and principles of the present invention, any changes made, equivalent replacement, improvement etc. shall be included in the scope of protection of the invention.

1. Service pricing method based on service industry auction system, the feature is
S1: To establish the service auction system
S2: To establish a model of the factors influencing the service price;
S3: according to the auction system historical transaction data to calculate the influence coefficient of each influence factor on the price;
S4: To predict future auction marketing reference price in service;
S5: According to historical transaction data to revise forecast market reference price constantly.

2. According to claim 1, the feature is: the S1 includes the steps of:
Auctioneers can enter personal information, including service industry, age, gender, geographic location, service time, service description, and the lowest price per hour for the auction, customers bid higher than the lowest price, at the end of the highest bidder wins the bid; we set up customer evaluation system and social recommendations functions.

3. According to claim 1, the feature is:
S2 includes:
The influencing factors of the service price are a1, a2, a3, a4, a5, a6, a7, the auction system set algorithm for each factor, which is used to measure the factors' impact value on the final service price:
a1: auctioneer's historical experience value:
a1=a11*P+a12*H;
P=auctioneer's average strike price;
H=auctioneer's total transaction time/the average total transaction time in the same industry*all of the auctioneers' average strike price in the same industry
a11 is coefficient of P on the auctioneer's historical experience value, a12 is coefficient of H on the auctioneer's historical experience value
T_aver=the average total transaction time in the same industry=total transaction time in the same industry/numbers of auctioneers in the transaction deal
H_rate=auctioneer's total transaction time/the average total transaction time in the same industry=auctioneer's total transaction time/T_aver;
Pw=all of the auctioneers' average strike price in the same industry=total avenue in the same industry/total transaction time in the same industry;
H=H_rate*Pw;
P_deal=Every time transaction price;
T_deal=Every time transaction time;
P=Σ(P_deal*T_deal)/ΣT_deal;
So a1=a11*Σ(P_deal*T_deal)/ΣT_deal+a12*H_rate*Pw;
According to the annual national services price statistics, suppose each service benchmark price is P0, P0 includes the industry, gender, age, geographic location and time of providing services, if the auctioneer has no historical experience on the platform, the system set is the reference initial price is P0.
a2: Customer comment value, the customer comments are provided by the auction service's buyers;
On the website listed customer comments score table, set full marks is 10, customer comment is divided into 1.2.3.4.5 five grades, 2Pw are transformed into a scale from 1 to 10. When an auctioneer's customer comments reach the average value of all of the website customer comments, the customer comment plays a role for Pw. If the auctioneer has no customer comments, the default is P0.
a2=⅕(K−K_aver)×Pw+Pw;
K=customer comments;
K_aver=average value of all of the website costomer comments
a3: The value of auctioneer's fans
If the total number of the website is N, the number of fans of the user who has the most fans is n, the average number of user's fans is m. If the probability of average repost is v, the total number of reading the post of user who has the most fans: n+n*m*v=n(1+m*v);
The number of fans of the user who has the average number of fans is m, the number of reading the post of user who has the average fans:
m+m*m*v=m(1+m*v);
By the above assumptions, a3 curve passes through three points: [0, 0], [m(1+mv), P0], [n(1+mv), 2 P0], we can use these three sets of data fitting a quadratic polynomial to quantify the role of fans in pricing:
data is: x=[0 m(1+mv)n(1+mv)]; y=[0 P0 2P0];
Poly=polyfit(x,y,2)=p; p is the 1×3 vector, p(1), p(2), p(3) are the coefficient of the quadratic polynomial,
This polynomial is p(1)×x̂+p(2)×x+p(3);
For the every user on the website, if the user's fans is n0, the total number of the user's fans:
N_fans=n0+n0*m*v=n0(1+m*v), the role of fans in pricing:
a3=f(N_fans)=p(1)*N_fans*N_fans+p(2)*N_fans+p(3)3
a4: The value of quantity of uploading certificates;
If the most certificates the auctioneer uploading is 10,
The average number of uploading certificates in one industry is Z_aver,
Z_aver=all of the uploading certificates in one industry/the number of auctioneer in the industry
When an auctioneer uploaded 10 certificates, the value of his/her certificates is 2P0: when an auctioneer uploaded the number of certificates as the same as the average number of the auctioneer's certificates on the website, the value of his/her certificates is P0; when an auctioneer did not upload certificates, his/her certificate value is 0. we can use these three sets of data fitting a quadratic polynomial to quantify the role of uploading certificates in pricing:
Data is: x=[0Z_aver 10], y=[0 P0 2P0]; poly=polyfit(x,y,2)=p,
Poly=polyfit(x,y,2)=p; p is the 1×3 vector, p(1), p(2), p(3) are the coefficient of the quadratic polynomial,
This polynomial is p(1)×x̂2+p(2)×x+p(3);
If an auctioneer uploading certificates in an industry is Z, a4=p(1)*Z*Z+p(2)*Z+p(3)
a5: Upset price
a5=P*=upset price;
If the auction upset price is more than 2 times of the average price, or less than half of the average price, the web site will not calculate the reference price, and not give the reference price,
a6: Friend's recommendation value.
Friend's recommendation value is composed of two parts: the person who recommends the user register the website and friends on the site recommendation after the user registered (friends here refer to not buying the service, friends' recommendation: agree, disagree.).
We take rankings and the number of followers to calculate the value of the recommendation on the site.
a6=a61*the value of the person who recommends the user register the website+a62*the value of friends on the site recommendation after the user registered:
a61 is coefficient of the value of the person who recommends the user register the website on the friends recommendation value,
a62 is coefficient of the value of friends on the site recommendation after the user registered on the friends recommendation value.
The value of the person who recommends the user register the website=a611*the value of the person ranking+a612*the value of the person's followers;
Pref=the value of the person who recommends the user register the website;
The person referred to recommend auction website role;
Ref_rank=rankings of the person who recommends the user register the website;
Pref_rank=value of the person who recommends the user register the website;
Pref_rank=(1−ranking/total number of persons)*P0;
Pref_fans=followers' value of the person who recommends the user register the website;
Pref_fans=f(Ref_fans);
followers' value of the person who recommends the user register the website is calculated in value of auctioneer's fans in a3:
f(Ref_fans)=p(1)*Ref_fans*Ref_fans+p(2)*Ref_fans+p(3);
Ref_fans)=number of Direct followers:
Ref_fans2=number of indirect followers;
Ref_fans=Ref_fans1+Ref_fans2;
As to friends on the site recommendation after the user registered: Recommendation on friends on the website:
Some friend recommendation value=all “agree” values+all “disagree” values;
Every “agree” value=a611*this friend's rank value+a612 the number of followers of this friend value,
Every “agree” value=−(a611*this friend's rank value+a612*the number of followers of this friend value),
a611 is coefficient of the friend rank value
a62 is coefficient of the number of followers value
Fri_rankA=friend's rank who published a “agree”;
Fri_fansA=The number of followers of the friend who published “agree”;
Fri_rankD=The ranking of the friend who published “disagree”;
Fri_fansD=The number of followers of the friend who published “disagree”
Pfri=the value of friends on the site recommendation after the user registered;
Pfri_rank=all friend's rank value=[Σ(1−Fri_rankA/N)]−Σ(1−Fri_rankD/N)*P0;
$$Pfri\_fans = Σ f ( Fri\_fansA ) - Σ f ( Fri\_fansD ) = [ p ( 1 ) * Fri\_fansA * Fri\_FansA + p ( 2 ) * Fri\_fansA + p ( 3 ) ] - [ p ( 1 ) * Fri\_fansD * Fri\_fansD + p ( 2 ) * Fri\_fansD + p ( 3 ) ] ;$$
For a certain industry, calculating each friend's recommendation value, in all of auctioneers who were recommended, using the lowest friend's recommendation value as the friend's recommendation minimum value Pmin, Pmin is 0, using highest friend's recommendation value as the friend's recommendation maximum Pmax,Pmax is 2p0, average recommendation value is Paver. Paver is p0
Paver=average recommendation value=total of all of the auctioneers's friends' recommendation values in this industry/number of auctioneers in the industry, so data is: (Pmin, 0), (Paver, P0), (Pmax, 2P0), with the three sets of data fitting a quadratic polynomial:
x=[Pmin, Paver, Pmax], y=(0, P0, 2P0], Poly=polyfit (x, y,2)=p, P is a 3×1 vector; if an auctioneer's friend's recommendation value is Pown, this auctioneer's friend's recommendation value: Pf=p(1)*Pown*Pown+p(2)*pown+p(3);
a6=a61*Pref+a62*Pfri
=a61*(a611*Pref_rank+a612*Pref_fans)+a62*(a611*Pfri_rank+a612*Pfri_fans)ₒ
a7: Auctioneer website ranking;
a7=(1−this auctioneer website ranking/total number of auctioneers)*average transaction price of all of the auctioneers in the industry.
=(1−Rank/N)*Pwₒ

4. According to claim 1, the feature is:
S3 includes: The influencing factors of the service price are a, a2, a3, a4, a5, a6, a7, corresponding the influence coefficients are x1, x2, x3, x4, x5, x6, x7, by all of the historical transaction price to calculate the influence coefficients.
$$\begin{matrix}Transaction price = a 1 * x 1 + a 2 * x 2 + a 3 * x 3 + a 4 * x 4 + a 5 * x 5 + a 6 * x 6 + a 7 * x 7 \\ = x 1 * ( a 11 * P\_aver + a 12 * H ) + x 2 * a 2 + x 3 * a 3 + x 4 * a 4 \\ + x 5 * a 5 + x 6 * ( a 61 * Pref + a 62 * Pfri ) + x 7 * a 7 \\ = x 1 * a 11 ( P\_aver - H ) + x 1 * H + x 2 * a 2 + x 3 * a 3 + x 4 * a 4 \\ + x 5 * a 5 + x 6 * a 61 * ( Pref - Pfri ) + x 6 * Pfri + ( 1 - x 1 - x 2 - … - x 6 ) * a 7 \\ = x 1 * a 11 ( P\_aver - H ) + x 6 * a 61 * ( Pref - Pfri ) + x 1 * ( H - a 7 ) \\ + x 2 * ( a 2 - a 7 ) + x 3 * ( a 3 - a 7 ) + x 4 * ( a 4 - a 7 ) + x 5 * ( a 5 - a 7 ) \\ + x 6 * ( Pfri - a 7 ) + a 7\end{matrix}$$
Because of the nonlinear equation, we use Newton method to solve this nonlinear equation, and get x1, X2, X3, x4, X5, X6, a11, a61.
According to 1, the feature is:
S4 includes: according to the coefficients in S3, the auction system can predicts the marketing reference price.

6. According to claim 1, the feature is: S5 includes: each of the seven groups of historical transaction data can be calculated by a group of influence coefficients, when the system of transaction data continues to increase, the system automatically use the historical transaction records and relevant information, to calculate multi groups of influence coefficients, to find coefficients changing regularities, so as to continuously modify the predicted marketing reference price.
